(19) United States
(12) Patent Application Publication
(10) Pub. No.: US 2023/0049417 A1
(43) Pub. Date: Feb. 16, 2023

(54) Portable Optic Stabilizing Carry Device

(71) Applicant: Colin Richard Buckingham, Silverton, OR (US)

(72) Inventor: Colin Richard Buckingham, Silverton, OR (US)

(21) Appl. No.: 17/888,463

(22) Filed: Aug. 15, 2022

Related U.S. Application Data
(60) Provisional application No. 63/233,266, filed on Aug. 15, 2021.

(51) Int. Cl. G02B 23/18

(52) U.S. Cl. CPC G02B 23/18

(57) ABSTRACT

An apparatus for securing and stabilizing devices which is further attached to a user. The apparatus is contoured along a surface to conform to a user's surface anatomy about the face, neck and upper chest area. An article mounting area, which is roughly rectangular in shape is located along the top of the apparatus. In one embodiment articles such as binoculars or cameras, are secured to the apparatus by way of straps. Straps or webbing couple the apparatus to the user. In one embodiment multiple straps attached to the apparatus are further attached to the user about the head, neck and upper chest areas. In one embodiment the apparatus is inflatable.

### CROSS-REFERENCE TO RELATED APPLICATIONS

This application claims the benefit of provisional patent application Ser. No. 63/233,266, filed 2021 Aug. 15 by the present inventor

### BACKGROUND-PRIOR ART

The following is a tabulation of some prior art that presently appears relevant:

### BACKGROUND

It has been shown in the prior art that there is a need to stabilize and carry optical devices to allow hands free use of optical devices. There is also a need to stabilize items under magnification to allow the user a clearer, stable view of the subject they are observing. Holding items such as a camera or binoculars can fatigue the user resulting in erratic movements and a poor viewing experience of the subject being observed. Multiple devices have been demonstrated to try and solve this problem but they all have noticeable drawbacks.

The most common approach to stabilize and hold optical devices such as cameras and binoculars is a tripod or stand that mounts to the optical device and rests on the ground or other surface. Tripods take time to set up and are not conducive for activites where you are moving locations frequently or viewing while on the move. Tripods also don't allow for easy or quick movements to view a fast moving subject such as an animal out in the field.

Wilbur Wong's Personal Binocular Support sought to fill the need in this area. Wong's device is said to include a base and means to attach base to user's body, a platform for holding optical device and a mechanical linkage interconnecting the two. The drawings in Wong's patent show many support structures, hinges, springs and such. Because of it's construction it would be cumbersome to store, pose multiple areas for mechanical failure, and because of the rigidity of materials used may impart or amplify small movements of the user to the optical device being used negatively effecting viewing performance.

Gary W. Baker's Wearable apparatus for providing support for articles is another example of a device to fill this need. Baker's device is similar to Wong's in that it is a hinged device that ancors to the user. Baker's device includes a frame, a first arm, and a second arm which are hinged and made of a rigid material. Baker's device poses some disadvantages to the user. The device may take considerable time to deploy and make proper adjustments for alignment of a optical device to the user's preference. Being that Baker's device is rigid it would transfer or amplifly movements from the user to the optical device resulting in poor sight picture of subject being viewed.

Vince S. Warner's Optical support device is yet another example. Warner's device uses a mounting plate which attaches to an optical device. The mounting plate has poles extending from the bottom which fit into a receptacle about a harness worn by the user. Like Baker's and Wong's devices, Warner's device uses a rigid component which would transfer and or ampliphy movements of the user to the optical device resulting in a less than desired outcome.

### SUMMARY

Accordingly, it is the object of the present invention to provide an improved method for carrying and using an optical device. I, Colin Richard Buckingham have invented a portable optic stabilizing carry device. The portable optic stabilizing carry device will be referred to as POSC for the duration of this document for simplicity. An article such as a camera, binoculars, scope, or video camera is mounted to an article mounting area which is roughly rectangular in shape and is roughly level. The article is secured by an article securement means to stabilize said article. An upper article tethering means prevents the article from falling off the POSC which may cause damage to the article. A user places his or her face, and or neck, and or upper body against an upper contour area and lower contour area which is designed to conform to the shape of the user. Straps or other means, referenced in this document as upper attachment means to user and lower attachment means to user hold the POSC to the user and can be adjusted for proper fit as well as detached for removal of the POSC from the user. In one embodiment the POSC is an inflatable which the user can inflate and deflate by way of a valve that provides access to an inner airtight chamber. When the POSC is deflated it can be stored in a stuff sack for transport. The POSC has a lower portable optic stabilizing carry device tethering means which can be attached to an item such as a back-pack, camera bag, or chest harness for transport. My POSC minimizes erratic movements experienced by users while holding an article which can effect the viewing experience especially when considering observing objects at magnification.

### DRAWINGS, FIGURES

FIG. 1 side perspective view of an embodiment of the POSC 20

FIG. 2 side view of the POSC 20 attached to a user 50 and an article 54

FIG. 3 side perspective view of the POSC 20

FIG. 4 top perspective view of an embodiment of the POSC 20

FIG. 5 front view of an embodiment of the POSC 20

FIG. 6 side broken view showing the internal features with multiple air chambers of an embodiment

FIG. 7 side perspective view of an embodiment of the POSC 20

### DRAWING REFERENCE NUMERALS

20 portable optic stabilizing device

22 article mounting area

23A accessory article mounting area

23B contour area of accessory article mounting area

24A right article securement means

24B left article securement means

26 attachment means for mounting area

28A upper article tethering means

28B lower portable optic stabilizing carry device tethering means

30A upper attachment surface

30B lower attachment surface

30M middle attachment surface

32 valve

32F front valve

32B back valve

33F upper front valve

33B upper back valve

40A upper contour area

40B lower contour area

40C detachable contour area

41 back surface of POSC

43 bottom surface of POSC

45A right side surface of POSC

45B left side surface of POSC

48 respiration area

48E respiration area outlet

49 nose contour area

50 user

52 chest harness

54 article

56A upper attachment means to user

56B lower attachment means to user

56C attachment means to user with chin support

57 cord

58 storage stuff sack

59 cord lock

60 bill of hat

60A hat with coupling means to user

62 hinge

66 coupling means to user

70F front air chamber

70B back air chamber

71F upper front air chamber

71B upper back air chamber

80 structural support means

80A structural support means coupling

80B structural support means attachment area

90 adjustable bottom support

Some of the embodiments of the POSC may have the following advantages over the prior art.
Relatively Light weight
Is less awkward to use and handle
Can be custom fitted to the user
Collapsible and easily stored
Minimizes erratic movements of articles
Contours to the user's surface anatomy to provide comfortable and stable viewing
Able to be quickly and easily repositioned
Able to be integrated with existing carry devices on the market
Comfortable and easy to use
Enables hands free usage

### First Embodiment

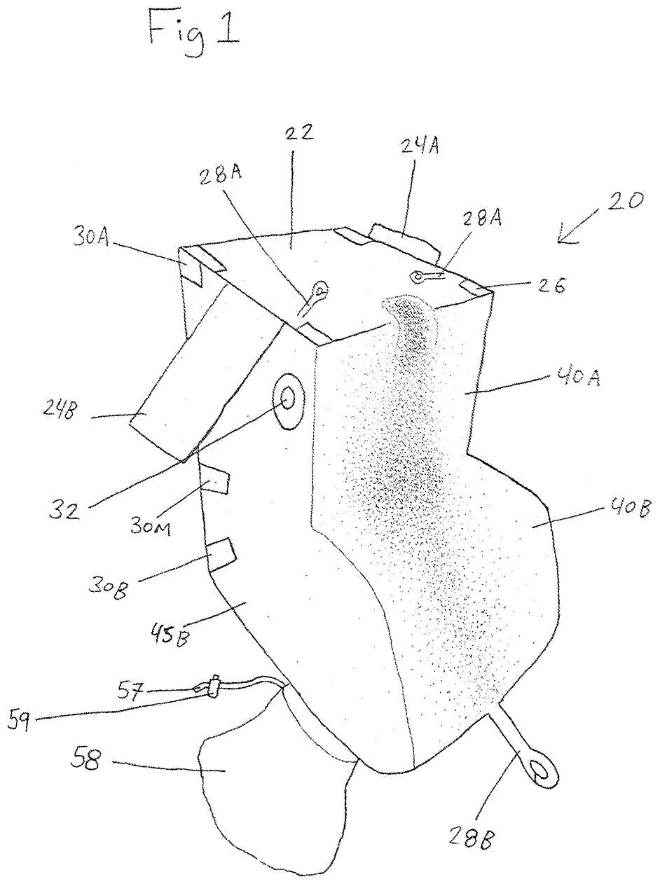

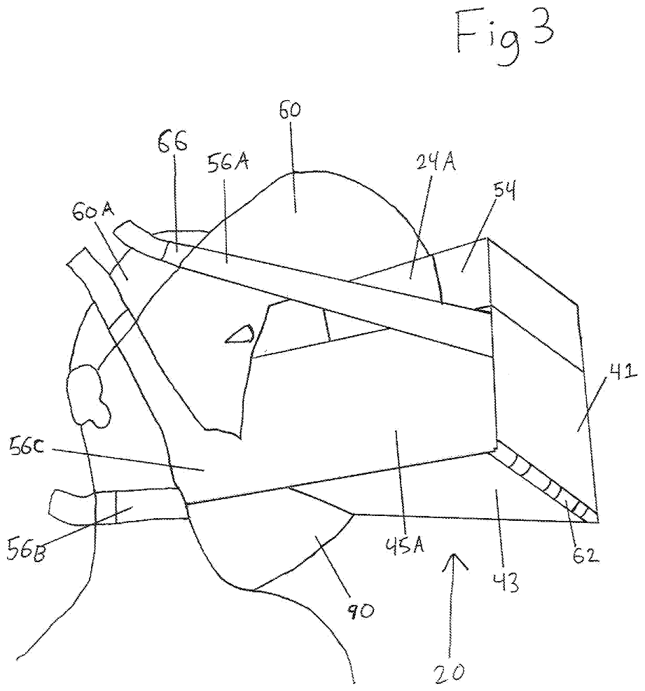

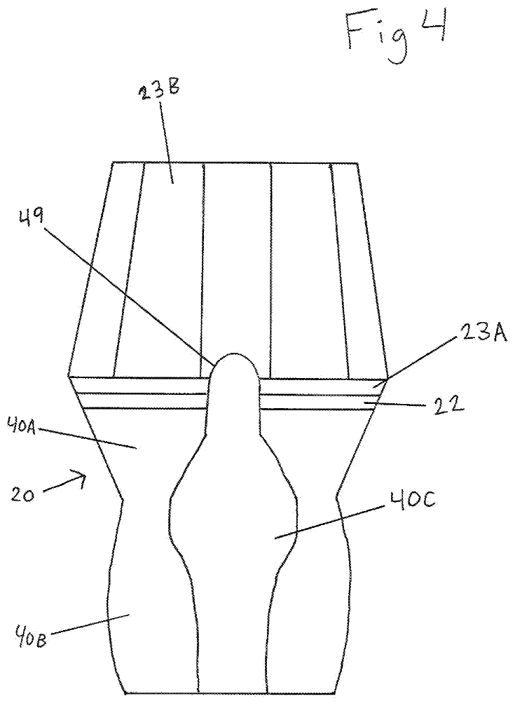

The dimensions of one embodiment of the POSC 20 (FIG. 1) is roughly 26 cm from the article mounting area 22 to the bottom surface of the portable optic stabilizing device 43 shown in FIG. 3, and roughly 22 cm from the back surface of portable optic stabilizing device to a lower contour area 40B at it's furthest distance from said back surface roughly where a lower portable optic stabilizing carry device tethering means 28B is shown. The article mounting area 22 is located on the top of the POSC 20, and measures roughly 13 cm by 13 cm. Said article mounting area 22 is where binoculars, cameras, and other articles are placed on the POSC 20. The article mounting area can be made of but no limited to: memory foam, foam, ABS, nylon, PVC, coated nylon, or PVC coated material, or a combination thereof. An upper article tethering means 28A attaches to articles to prevent separation of said articles from the POSC 20. One example of this would be a threaded bolt along the surface that screws into binoculars in what is referred to as the tripod socket. The upper article tethering means can consist of but not limited to: a carabiner, hook and loop strap, clasp, strap with button and button hole, side release buckle, split ring, threaded bolt, threaded bolt with cordage, or cordage with locking mechanism. Along the surface of the article mounting area 22 are attachment means for mounting area 26. The attachment means for mounting area 26 allows for attachment of accessory mounting areas 23A, shown in (FIG. 4). Along the sides of the article mounting area 22 is a right article securement means 24A, and a left article securement means 24B. Said article securement means 24A, 24B make contact with an article helping to stabilize it and make it more secure. Shown in (FIG. 1) is a left article securement means 24B which can couple and uncouple to a right article securement means 24B. Article securement means can consist of but not limited to: strap with hook and loop, strap with side buckle release, netting, strap with button holes and buttons on opposite side.

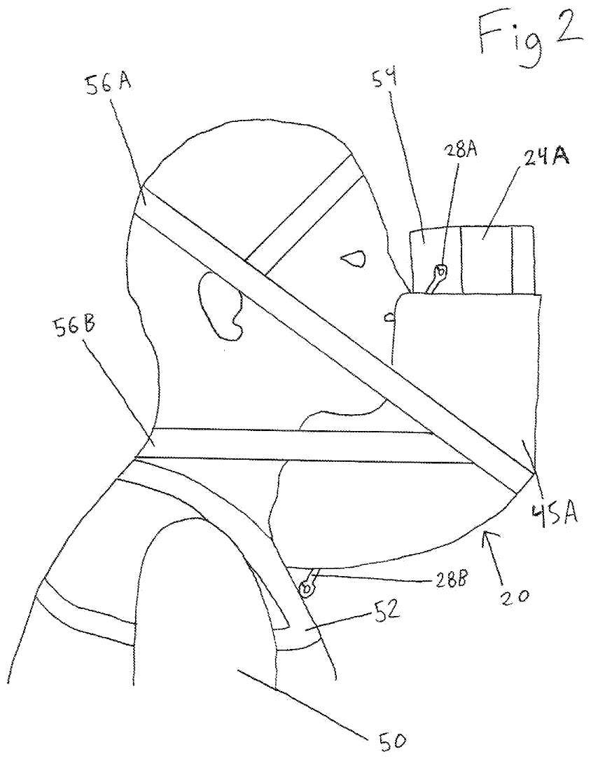

The POSC 20 has a left side surface 45B with an upper attachment surface 30A, a middle attachment surface 30M, and a lower attachment surface 30B, which consist of but not limited to: hook and loop, snap fasteners, or buckles. Said attachment surfaces are also located on a right side surface 45A shown in (FIG. 2). Said attachment surfaces couple to upper attachment means to user 56A and lower attachment means to user 56B that aid in securing the POSC 20 to a user 50 shown in (FIG. 2) and (FIG. 3). An upper attachment means to user 56A connects along the side of the POSC 20 and is in contact about the user's head area. A lower attachment means to user 56B is attached along the side surface of the POSC 20 and is in contact about the user's neck area. Said upper and lower attachment means to user can consist of but not limited to: nylon straps or webbing, or polyester straps or webbing. Said upper and lower attachment means to user can be coupled and decoupled by way of the upper attachment surface 30A, middle attachment surface 30M, and lower attachment surface 30B shown in FIG. 1 from the POSC 20. Length of said attachment means to user can be adjusted with the aid of but not limited to: cinching straps, cam buckle, tri-bar adjustable webbing slide, side release buckle straps, or hook and loop fastener straps (not shown). A valve 32 is shown in FIG. 1. Said valve is similar those found on common inflatables and allows user to blow air or other gasses into an airtight inner chamber (not shown) and close said valve. The outside surface of the POSC may consist of a common durable material that functions as a shell. Shell material can consist of but not limited to: nylon, polyester, “flocked” coated or fabric covered vinyl, similar to that used on inflatable mattresses. The shell material may be removed from the inner air tight chamber for cleaning purposes. The shell material can be removed and reattached to the POSC by means of but not limited to: hook and loop, zipper, snap closures, buckles, magnets (not shown). (FIG. 1) shows the POSC 20 in the inflated state. A user can open said valve to deflate the POSC 20 to make it easier to store and transport. The user can then place the POSC 20 into a storage stuff sack 58 and close the opening with the aid of cordage 57 and a cord lock 58.

The user makes contact with the POSC 20 along the upper contour area 40A, and the lower contour area 40B. The upper contour area 40A and lower contour area 40B can be made of but not limited to: memory foam, foam, ABS, nylon, PVC, coated nylon, or PVC coated material. The user contacts or is in close proximity to the upper contour area 40A from roughly the nose to roughly the chin. The user contacts or is in close proximity to the lower contour area 40B from roughly the chin to roughly the base of the neck. Said contour areas roughly follow the contours of the surface anatomy of the anterior and or sides of the face and neck. A lower portable optic stabilizing carry device tethering means 28B is located at the bottom of the lower contour area 40B. The lower portable optic stabilizing carry device tethering means 28B can attach to a shoulder harness, backpack, or other items allowing the user to detach and or loosen straps from said upper and lower attachment means to user 56A, 56B and still have the POSC 20 within reach. This may be advantageous to hunters wanting to quickly clear the POSC 20 from the space along the users face and neck area.

### Operation

A user 50 places an article upon the article mounting area 22 and secures it to the POSC 20 by way of right article securement means 24A, left article securement means 24B and upper article tethering means 28A. In the case of the inflatable POSC the user would blow into the valve 32 to inflate an inner air tight chamber and then close the valve. The user then would place his or her face against the upper contour area 40A and his or her neck and or chest against the lower contour area 40B. The user then would place the upper attachment means to user 56A on his or her head and the lower attachment means 56B around his or her neck and or chest area. The user can attach the POSC 20 to a chest harness, backpack, or other accessory by way of the lower portable optic stabilizing carry device tethering means 28B. User can adjust fit by tightening or loosening straps on the upper and lower attachment means to user by way of a buckle slider. The user can quickly detach from the POSC by uncoupling the attachment means to user by way of buckle attachment on the POSC from the upper, middle, lower attachment surface 30A, 30M, 30B. For easy storage the POSC can be deflated and place within the storage stuff sack 58.

### Additional Embodiment

(FIG. 3) is a side perspective view of an embodiment of the POSC 20. An embodiment is shown (FIG. 3) with a hinge 62 that can be locked in a certain position which connects a back surface of portable optic stabilizing carry device 41 to a bottom surface of portable optic stabilizing device 43. Said back and bottom surfaces are made out of a rigid or semi-rigid material such as ABS, polypropylene, UHMW, acrylic, or nylon. This arrangement allows for increased structure while the hinge 62 can be folded towards the user to make the POSC more compact for storage or carry. An adjustable bottom support 90 is shown along or in close proximity to the bottom surface of portable optic stabilizing carry device 43 and roughly in the area of the user's neck and or chest. The adjustable bottom support 90 can detach and reattach from the POSC 20 by way of but not limited to: hook and loop, buckles, snap fasteners, or magnets (not shown). The adjustable bottom support 90 is designed to change the viewing angle and or provide a more comfortable and stable experience for the user. The adjustable bottom support 90 can be made of but not limited to: a second air chamber with a valve (not shown), foam, rigid or semi-rigid material. A lower attachment means to user 56B is shown about the user's neck. An attachment means to user with chin support 56C is shown. In the embodiment shown in (FIG. 3) there is a hat 60A with coupling means to user 66. For clarity I have labeled a bill of the hat 60. An upper attachment means to user 56A is attached on a right side surface of portable optic stabilizing device 45A and is further attached to said hat 60A by way of a coupling means to user 66, features are further located on the left side as well. Said coupling means to user 66 functions to adjust the length of the upper attachment means to user 56A to provide a customized fitting of the POSC 20, as well as a point of attachment and detachment for quick and easy repositioning of the POSC 20. The coupling means to user 66 can be present in other locations such as on the lower attachment means to user 56B.

### Additional Embodiment

(FIG. 4) is a top perspective view of an embodiment of my POSC 20. An accessory article mounting area 23A is attached to the article mounting area 22 by way of the attachment means for mounting area 26 shown in (FIG. 1). Said accessory mounting area 23A can consist of but not limited to: sloped platform to provide different viewing angles, contoured surfaces that are specific to particular models of optics or other articles, enclosed space with a multitude of repositionable media such as segments of resin or pellets or beads which may resemble what is commonly referred to as a “bean bag”, or foam with differing density and properties. An example of the contour area of accessory article mounting area 23B is shown which conforms to the shape of binoculars. A nose contour area 49 is shown which is a recess in the POSC to allow a better fit for the user. A detachable contour area 40C is shown which fits into a void along the surface of the upper contour area 40A and the lower contour area 40B. The purpose of the detachable contour area 40C is to better conform to different shapes and sizes of multiple users by removing one and inserting another. The removable contour area 40C attaches to the POSC 20 by way of but not limited to: buckles, hook and loop, snap fasteners, rib and slot, or magnets (not shown). The detachable contour area 40C can be made of but not limited to: foam, memory foam, moldable plastics, mesh, netting, Kydex, or a combination thereof.

### Additional Embodiment

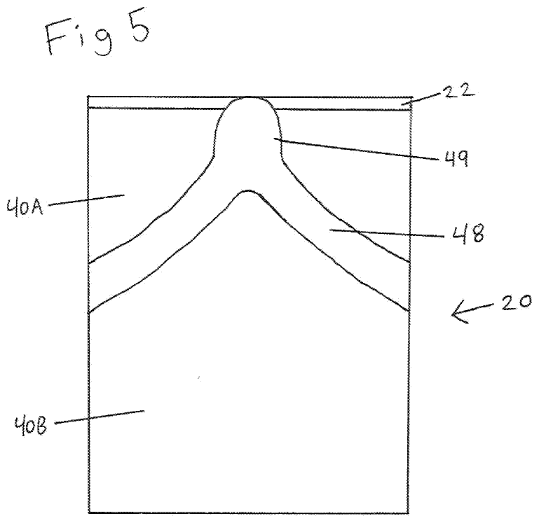

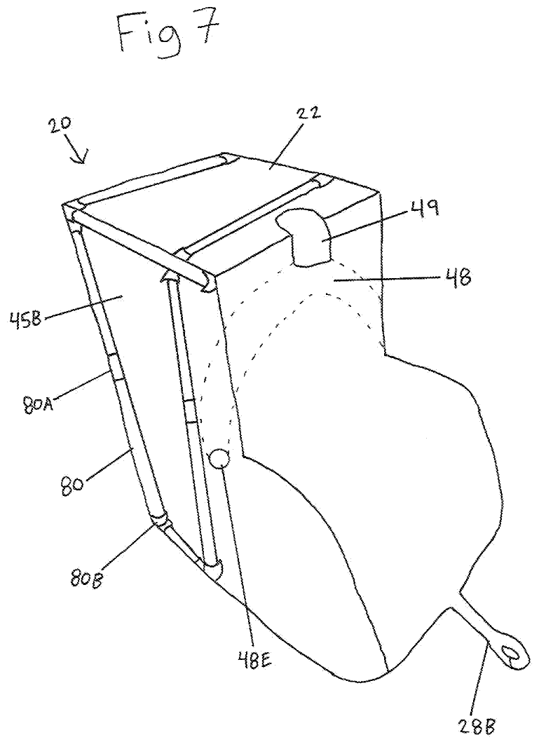

(FIG. 5) is a front view of an embodiment of my POSC 20. (FIG. 5) omits several features from the drawing for clarity. The POSC 20 is made out of a solid piece of durable foam. The solid piece of foam has a shell material covering that protects the foam and acts as a surface for the attachment of several features including, but not limited to: accessory article mounting area 23A, upper, middle, lower attachment surface 30A, 30M, 30B, right article securement means 24A, left article securement means 24B, upper article tethering means 28A and lower portable optic stabilizing carry device tethering means 28B (not shown). A respiration area 48 is shown which is a depression on the surface of the POSC 20 that is next to a nose contour area 49. The respiration area helps divert the exhales of a user's nose away from the article mounting area 22. This may help prevent fogging of optics placed on the article mounting area 22 as well as provide a more enjoyable experience. The respiration area 48 can also be a number of voids or channels that are located internally on the POSC 20 which originate along or in close proximity to the nose contour area 49 (not shown). Said voids or channels can extend through the POSC and be in contact with the ambient air beyond the POSC exiting at respiration area outlet 48E, shown in detail in (FIG. 7).

### Additional Embodiment

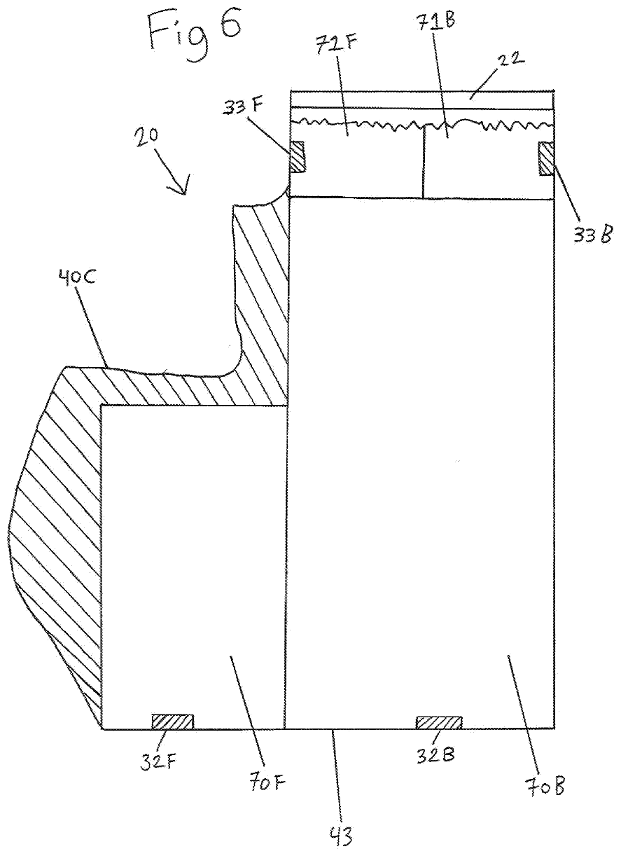

(FIG. 6) is a side broken view showing the internal features of an embodiment. Along a bottom surface of portable optic stabilizing carry device 43 is a front valve 32F which is in contact with a front air chamber 70F, and a back valve 32B which is in contact with a back air chamber 70B. An upper front valve 33F is in contact with an upper front air chamber 71F, and an upper back valve 33B is in contact with an upper back air chamber 71B. A detachable contour area 40C is shown which can be custom molded or shaped to a specific user. Said detachable contour area 40C attaches to an exterior surface or surfaces of said air chambers (not shown). A user can open said valves and blow into them to inflate said air chambers to varying pressure which may provide better contact or support for an article and or the user. More or less air chambers can be present and in different locations.

### Additional Embodiment

(FIG. 7) is a side perspective view of an embodiment of my POSC 20. (FIG. 7) omits several features from the drawing for clarity. A respiration area 48 is shown which in this embodiment consists of an internal void below and to the side of a nose contour area 49 which exits along a left side surface of portable optic stabilizing carry device 45B at a respiration area outlet 48E. The respiration area outlet 48E is also located along a right side surface of portable optic stabilizing device 45A (not shown).

Along the left side surface of portable optic stabilizing carry device 45B is a multitude of structural support means 80 that are secured to the POSC 20 by a structural support means attachment area 80B. The structural support means 80 can be separated into shorter segments by way of a structural support means coupling 80A. Said structural support means 80, said structural support means attachment area 80B, and said structural support means coupling 80A are located on or in close proximity to an article attachment area 22 and the right side surface of portable optic stabilizing device 45A (not shown). The structural support means 80 can consist of but not limited to: aluminum rods or cylinders which are solid or hollow, fiberglass rods or cylinders which are solid or hollow, plastic rods or cylinders which are solid or hollow, hollow poles which are linked together by an elastic cord resembling a tent pole, rectangular segments of plastic, or rigid or semi-rigid material in various shapes. Along the ends of the structural support means 80 can be a component of a hook and loop or snap closure which mates with a component of a hook and loop or snap closure along the structural support means attachment area 80B. Along the ends of the structural support means 80 can be male or female threads. The structural support means attachment area 80B can consist of but not limited to: a pocket with an open end which a rod or other shape can be inserted, snap closure component, or hook and loop component. The structural support means coupling 80A can consist of but not limited to: male or female threads which the ends of the structural support means 80 can screw into, a hub that has an inside diameter the size of an outside diameter of a rod or pole which is a structural support means 80.

The features described in (FIG. 7) allows a user to reinforce the POSC 20 enabling it to hold it's shape better under force or stresses. The internal channels divert nose exhalations away from articles and provides a more comfortable experience.

These are not the only embodiments of my invention. Alternatively:
Any of the features or components of the described embodiments can be in different locations on the POSC 20 than those depicted in the figures.
Any of the features or components of the described embodiments can be in greater or lesser quantity or number than those depicted in the figures.
Any of the features or components of the described embodiments can be present or absent from a particular embodiment.
Different materials, sizes and interconnections can be used for all components.
Different shapes can be used for all components.
The POSC 20 can have an additional contour area which is located along or in close proximity to the chest of a user.
A tube or projection can extend from a valve to accommodate inflation of air chambers.
Different methods and components can be used for inflation of air chambers consisting of but not limited to: an internal inflation mechanism, a hand bulb air pump, a one way check valve, a tube or projection extending from a valve for inflation purposes, or a combination thereof.

### Conclusion, Ramifications, and Scope

Although the description above contains many specificities, these should not be construed as limiting the scope of the embodiments but merely providing illustrations of some of several embodiments.

Thus the scope of the embodiments should be determined by the appended claims and their legal equivalents, rather than by the examples given.

I claim:

1. A portable optic stabilizing carry device comprising:
a. an article mounting area with attachment means for an article
b. an upper contour area and a lower contour area which roughly follows the contours of a user's face, neck and or chest
c. an attachments means for said portable optic stabilizing carry device to said user

2. The device of claim 1 wherein a outer shell and an air bladder are present and a valve or means to fill said air bladder

3. The device of claim 2 further comprising a multitude of air chambers and a multitude of means to fill said air chambers

4. The device of claim 2 further comprising a structural support means located along an exterior surface of said portable optic stabilizing device

5. The device of claim 1 further comprising a recess and or channel originating along the upper contour area for diverting exhalations away from said upper contour area

6. The device of claim 1 further comprising a upper and lower means for tethering an article to said portable optic stabilizing device

7. The device of claim 1 further comprising an accessory article mounting area which is contoured to specific articles

8. The device of claim 1 further comprising a detachable contour area located along said upper and said lower contour area

9. The device of claim 2 further comprising a detachable contour area located along said upper and said lower contour area

10. The device of claim 2 further comprising a storage bag

11. The device of claim 2 further comprising a removable shell

12. The device of claim 1 further comprising a removable shell

13. A method for carrying articles
comprising:
a. providing an article mounting area comprising an article securement means, an upper article tethering means, a upper and lower contour area which roughly follows the contours of a user face and neck, an upper, middle and lower attachment surface and a lower portable optic stabilizing carry device tethering means,
b. providing an article and placing it to said article mounting area and securing with said article securement means
c. securing a attachment means to said user and said attachment surfaces whereby said article is supported by said article mounting area and said upper and lower contour areas and secured to said user for stabilization and use of said article.

14. The method of claim 13 wherein the upper and lower contour areas consists of a shell with a airtight chamber disposed within and a means to fill said air tight chamber
